(19) United States
(12) Patent Application Publication
(10) Pub. No.: US 2016/0004766 A1
(43) Pub. Date: Jan. 7, 2016

(54) SEARCH TECHNOLOGY USING SYNONIMS AND PARAPHRASING

(71) Applicant: ABBYY InfoPoisk LLC, Moscow (RU)

(72) Inventors: Tatiana Danielyan, Moscow (RU); Evgeny Indenbom, Moscow (RU)

(21) Appl. No.: 14/857,649

(22) Filed: Sep. 17, 2015

Related U.S. Application Data
(63) Continuation-in-part of application No. 14/142,701, filed on Dec. 27, 2013.
Application No. 14/142,701 is a continuation-in-part of application No. 13/173,649, filed on Jun. 30, 2011, now Pat. No. 9,069,750.
Application No. 13/173,649 is a continuation-in-part of application No. 13/173,369, filed on Jun. 30, 2011, now Pat. No. 9,098,489.
Application No. 13/173,369 is a continuation-in-part of application No. 12/983,220, filed on Dec. 31, 2010, now Pat. No. 9,075,864.
Application No. 12/983,220 is a continuation of application No. 11/548,214, filed on Oct. 10, 2006, now Pat. No. 8,078,450.

(30) Foreign Application Priority Data
Jul. 2, 2015 (RU) 2015126477

(51) Int. Cl. G06F 17/30; G06F 17/27

(52) U.S. Cl. CPC G06F 17/30663; G06F 17/2785; G06F 17/30684

(57) ABSTRACT

The present invention is a method and a system of organizing information searches in electronic text corpora and displaying the search results in the user interface. The system and the method enable searches not just for words or word combinations, but also for specific lexical meanings of words, where a lexical meaning is a realization of a word's semantic meaning in a particular language. The completeness of search results is bases on incorporation synonyms and paraphrases in the search. The method also includes searching for fragments matching the query in electronic text corpora, estimating the results and the displaying the results ranked to the user.

### CROSS REFERENCE TO RELATED APPLICATIONS

This application is a continuation-in-part of U.S. patent application Ser. No. 14/142,701, filed Dec. 27, 2013 which is a continuation-in-part of U.S. patent application Ser. No. 13/173,649 filed Jun. 30, 2011, now U.S. Pat. No. 9,069,750, issued Jun. 30, 2015, and is also a continuation-in-part of U.S. patent application Ser. No. 13/173,369, filed on Jun. 30, 2011 which is a continuation-in-part of U.S. patent application Ser. No. 12/983,220, filed on Dec. 31, 2010, now U.S. Pat. No. 9,075,864, issued Jul. 7, 2015 which is a continuation-in-part of U.S. patent application Ser. No. 11/548,214, filed on Oct. 10, 2006, now U.S. Pat. No. 8,078,450, issued Dec. 13, 2011. This application also claims priority under 35 USC 119 to Russian patent application No. 2015126477, filed Jul. 2, 2015; the disclosures of all of the priority applications are herein incorporated by reference in their entirety.

### FIELD OF INVENTION

The present invention concerns search technology. More specifically, this invention's embodiment concerns searching for available electronic content, such as on the Internet or in other electronic resources, for example, text corpora, dictionaries, glossaries and encyclopedias. It also concerns the methods of representing the search results.

### BACKGROUND

There are popular search technologies that return results based on keywords entered by the user in a search query.

However, due to the homonymy and homography inherent to natural languages, a keyword-based search can return a significant amount of irrelevant or hardly relevant information. For example, if the user searches for texts containing the word “page” in the sense of a court post, the results will contain a large amount of irrelevant information with the word “page” referring to web-pages, newspaper and magazine pages, memory device pages, etc. This happens because these meanings are much more frequent than “page” with the lexical meaning of “servant”. Similarly, in Russian, searching for the keyword “ [symbol] ” (window) may return all texts containing the verb “ [symbol] ” (to flow) as well as all of its word forms.

The existing search systems allow the use of simple query languages to search for documents that contain or do not contain a word or several words entered by the user. However, the user cannot specify whether or not these words should be present in one sentence. Nor can the user create a query for several words belonging to a certain class or having certain properties or characteristics. As a rule, in such systems, a query cannot be phrased as a regular question in a natural language.

To refine the search value, it is often needed to provide additional words to the query. Besides, in some cases, user herself does not know which one of the word's meanings represents the user's interests. This may be the case, for example, when the user searches for usage options of an unknown word in a foreign language. Large and unorganized volume of search results allows the user to see all possible meanings or usages of the searched word or phrase.

Another problem is that the same information can communicated with different words or phrases, including synonyms and paraphrases, in different documents or even in the same document.

The present invention constitutes an elaboration of the solutions set forth in U.S. patent application Ser. Nos. 13/173,649 and 13/173,369, filed on Jun. 30, 2011, and Ser. No. 12/983,220, filed on Dec. 31, 2010, as well as U.S. patent application Ser. No. 14/142,701, filed on Dec. 27, 2013. This invention also partially relies on the analysis technology patented in the U.S. (U.S. Pat. No. 8,078,450).

### SUMMARY

The present invention represents a method and a system of organizing an informational search in electronic text corpora for computer systems and displaying the search results in user interface, a method with the following steps carried out at least once: receiving of search query, including one or several word groups; disambiguation, that is, a single lexical meaning is unambiguously defined for each query work, or a list of lexical meanings with relevant weights is formed. Lexical meaning is an implementation of certain semantic meanings in specific language. To get the most information as a result of the query, each lexical meaning in a query can be “extended” by adding a list of its synonyms. Synonyms, however, can be incomplete equivalents, because each synonym receives a certain assessment (weight), and the list is ranked in descending order. Search in progress. The search is performed so that not only words or lexical meanings present in the query are requested but also the synonyms from the returned list. According to assessment (weight) of the synonym, the returned result also receives some assessment that directly depends on the assessment (weight) of the synonym. Search results are ranked according to assigned assessments.

In addition, this method can be applied not only to individual words but also to groups of words. These equivalent or partially equivalent speech patterns we will call paraphrases. This method also includes search for fragments in electronic text corpora satisfying conditions of the query and display of the search results for the user. In certain implementations, a list of lexical meanings for groups of words forming the query may be formed based on a query to semantic hierarchy and filtered based on syntactic-semantic analysis of the query in order to exclude the lexical meanings with impossible combinations.

One implementation performs full text search, that is, the search at any indexed corpora with further analysis of found fragments and filtration of the search results based on possible lexical meanings of a search query.

Other implementations may include a semantic search among text corpora after preliminary deep syntactic-semantic analysis and indexing for search of specific lexical meanings

Implementation of this invention allows a user to search and find the most complete and relevant information and receive the search results ranked by relevance. If a query is formulated in the form of a question in natural language, a parser is used to analyze the query, recognize its syntactic structure, constructs its semantic structure, so that the system could “comprehend” the meaning of the query. Thus, the user can receive only relevant search results.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 illustrates a flow diagram of a process for preprocessing text corpora in a natural language prior to processing semantic searches;

FIG. 1A illustrates a process for performing the deep analysis of the text corpus;

FIG. 2 illustrates a sequence of structures created during process of analysis of sentence;

FIG. 3 illustrates a syntactic tree obtained as a result of a precise syntactic analysis of the English sentence “This boy is smart, he'll succeed in life.”

FIG. 4 illustrates a semantic structure obtained as a result of analysis of the English sentence “This boy is smart, he'll succeed in life”;

FIG. 5A illustrates a fragment of a semantic hierarchy;

FIG. 5B illustrates a fragment of a semantic hierarchy;

FIG. 5C illustrates a fragment of a semantic hierarchy;

FIG. 5D illustrates a fragment of a semantic hierarchy;

FIG. 6 is a diagram illustrating linguistic descriptions;

FIG. 7 is a diagram illustrating morphological descriptions;

FIG. 8 is a diagram illustrating syntactic descriptions;

FIG. 9 is a diagram illustrating semantic descriptions;

FIG. 10 is a diagram illustrating lexical descriptions;

FIG. 11A illustrates graphical user interfaces displaying search results of semantic queries;

FIG. 11B illustrates graphical user interfaces displaying search results of semantic queries;

FIG. 12 illustrates exemplary hardware for implementing the searching system.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept. The implementation of the present invention discloses a method of extended information search in texts in natural language and methods for displaying search results.

The methods of information search include a full text search and a semantic search. Full text search can be performed on an arbitrary text corpora having a normal full text (direct or reverse) index. Such search does not require time-consuming pre-processing, index for such search is compact, and required resources for such index are virtually unlimited. This type of search is used by many well-known search engines, such as Google, Yahoo, Yandex, etc. The week point of full text search is that in some cases it produces a large volume of irrelevant information.

Semantic search requires a preliminary processing of text corpora being searched, normally by marking (or tagging), for example, by part of speech, entity, class, etc. The preprocessing includes building of a complicated index. The resulting index is much more space-consuming, and, as a result, the semantic search using this complex index is much slower than the full text search. The advantage of the semantic search, however, is its high accuracy and increased relevance of the obtained search results.

The U.S. Pat. No. 8,078,450 describes a method that includes deep syntactic and semantic analysis of natural language texts based on comprehensive linguistic descriptions. This method can be used at the analysis stage of the described method in building indices. The method uses a broad spectrum of linguistic descriptions, both universal semantic mechanisms and those associated with the specific language, which allows all the real complexities of the language to be reflected without simplification or artificial limits, without any danger of a combinatorial explosion, or an unguided growth in complexity. This method is used both for disambiguation of search query and for building of semantic index. The linguistic descriptions created for this method are used both to obtain a set of alternative formulations of a query and for assessment of the relevance of found results.

With certain modifications, this method is applicable for both full-text and semantic search. Therefore, we will describe a general algorithm specifying what needs to be done additionally for a certain type of search.

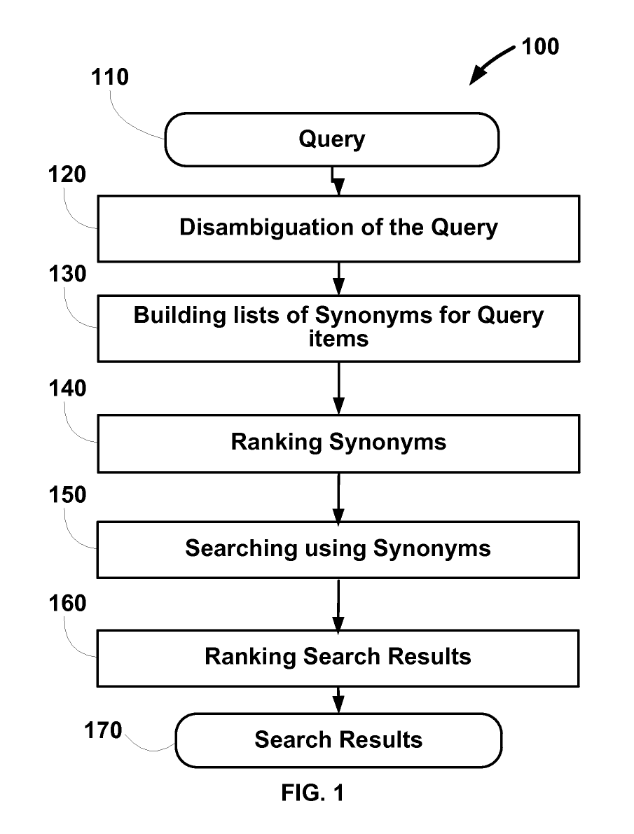

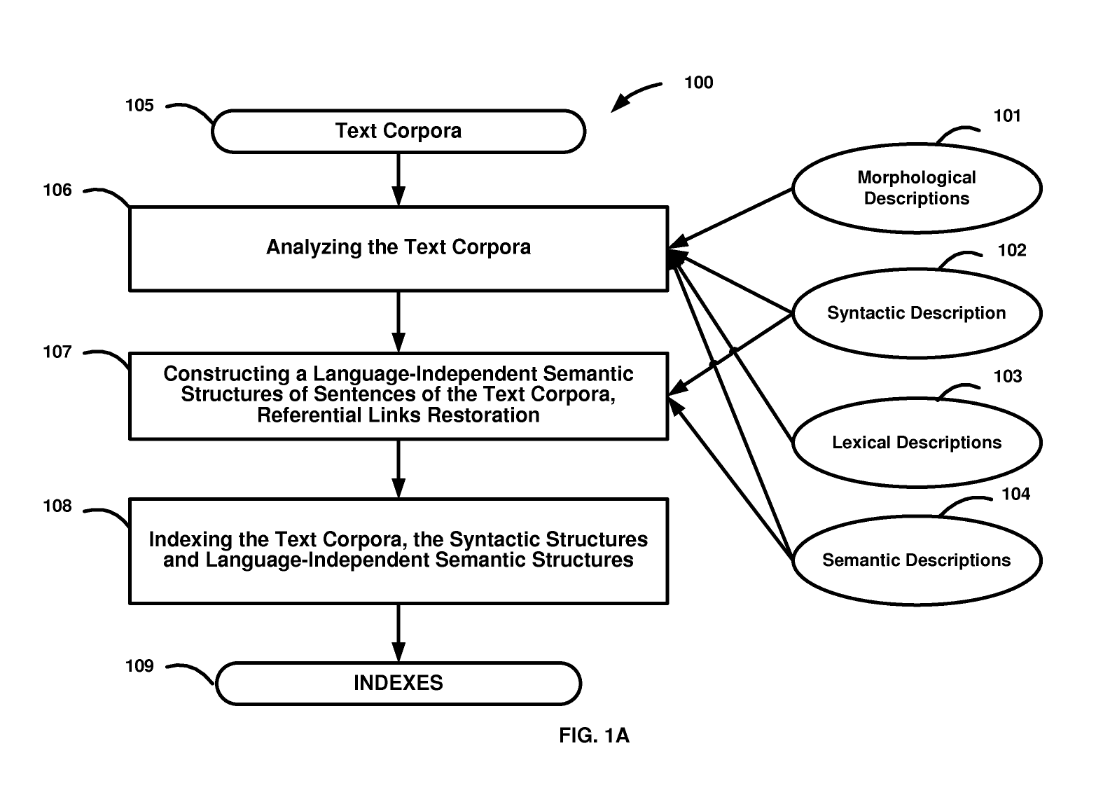

FIG. 1 illustrates a flow diagram of method 100 for information search in text corpora in accordance with one embodiment of the invention. Texts to be searched must be preliminarily indexed (not shown in FIG. 1), which means that one or more indexes are built for each corpus or text. For a full-text search, this may be an ordinary index—direct or inverted. For a semantic search, the text corpus is subjected to deep semantic-syntactic analysis based, for example, on methods described in the U.S. Pat. No. 8,078,450. Text parameters relevant to the semantic search are also indexed prior to searching.

FIG. 1A illustrates a process (100) for performing the deep analysis of the text corpus and the construction of indices in accordance with one implementation related to implementation of semantic search. The deep analysis 190 may include lexical-morphological, syntactic and semantic analysis of each sentence of the text corpus, resulting in the construction of language-independent semantic structures in which each word of text is assigned to a corresponding semantic class. The deep analysis also results in disambiguation of the words/phrases in the texts, i.e. now the particular lexical meaning of each word is recorded for its context.

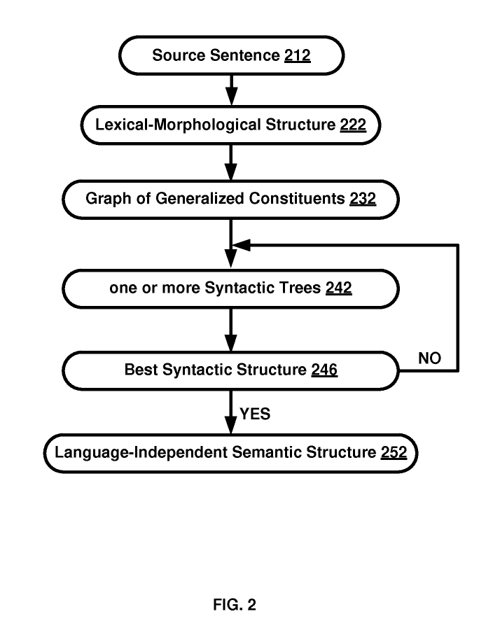

The text corpus (105) is subjected to exhaustive semantic-syntactic analysis (106) with the use of linguistic descriptions of the source language and of universal semantic descriptions, which makes it possible to analyze not only the surface syntactic structure but also the deep semantic structure that expresses the meaning of each sentence and the links between sentences or text blocks. Linguistic descriptions may include lexical descriptions (101), morphological descriptions (102), syntactic descriptions (103) and semantic descriptions (104). The analysis (106) includes a syntactic analysis done as a two-stage algorithm (rough syntactic analysis and precise syntactic analysis) using linguistic models and information at various levels to compute probabilities and generate the most likely (“best”) syntactic structure. FIG. 2 illustrates the sequence of structures formed during the analysis of the sentence according to one embodiment.

Next, a language-independent semantic structure (107) is built or generated, which constitutes the meaning of the given sentence.

Then, the original sentence, syntactic structure of the original sentence and the language-independent semantic structure are indexed (108). The result is a set of a collection of indices (109). The index can usually be presented in a table, where each value of a textual feature (e.g., a word, expression or phrase, relation between the elements of the sentence, morphological, lexical, syntactic or semantic feature, as well as syntactic and semantic structures) in the document is associated with a list of addresses of their occurrences in that document. In one embodiment, morphological, syntactic, lexical and semantic characteristics, and also structures and structural fragments can be indexed in the same way as a word in the document is indexed.

In one embodiment, indices can include all or at least one value of the morphological, syntactic, and lexical semantic characteristics (parameters). These values or parameters are generated during a two-stage semantic analysis, described in more detail hereinafter. Indices can be used in many tasks involved in processing natural language, particularly in organizing semantic searches. According to one implementation, the morphological, syntactic, and lexical semantic descriptions are structured and stored in the database. This set of instructions may include, at minimum, the morphological language model, the model of syntactical constructions for the language, and lexical-semantic models. In one embodiment, for the analysis of complex language structures, recognition of the meaning of the sentence and the correct transfer of the information contained therein, an integrated model is used to describe the syntax and semantics.

FIG. 2 illustrates a diagram of a process for analyzing a sentence in accordance with one embodiment. In particular, a source sentence 212 is converted into a language independent semantic structure 252 through various structures. Using at least in part the process and structures illustrated in FIGS. 1A and 2, the lexical-morphological structure (222) is determined at the stage of analysis (106) from the source sentence (105). Next, a syntactic analysis, which may be implemented as a two-stage algorithm (a rough syntactic analysis and a precise syntactic analysis), is performed using linguistic models and information at various levels to compute probabilities and generate the most likely (“best”) syntactic structure.

A rough syntactic analysis is applied to the source sentence and includes, in particular, the generation of all potential lexical meanings for words that make up the sentence or phrase, of all the potential relationships among them and of all potential constituents. All possible surface syntactic models are applied for each element of the lexical-morphological structure. Then, all possible constituents are created and generalized so as to represent all possible variations of the syntactic parsing of the sentence. The result is the formation of a graph of generalized constituents (232) for subsequent precise syntactic analysis. The graph of generalized constituents (232) includes all the potential links within the sentence. The rough syntactic analysis is followed by precise syntactic analysis on the graph of generalized constituents, resulting in the “derivation” of a certain number of syntactic trees (242) that represent the structure of the source sentence. Construction of a syntax tree (242) includes a lexical selection for the nodes in the graph and a selection of the relationships between the nodes of the graph. A set of a priori and statistical scores may be used when selecting lexical variations or when selecting relationships from the graph. A priori and statistical scores may also be used both to evaluate the parts of the graph and to evaluate the entire tree. In one implementation, one or more syntactic trees are built or arranged in descending value. Thus, the best syntactic tree will be the first one constructed. At this time, the non-tree links are also checked and constructed. If the first syntactic tree is not appropriate, for example, because of the impossibility of establishing the necessary non-tree links, then the next syntactic tree is regarded as the best, and so on. Lexical selection essentially means disambiguation (FIG. 1, 120).

Since said lexical selection for the nodes of the graph and the selection of relationships between nodes takes place on the basis of a priori and statistical assessments, one implementation of the method not only examines and assesses all variants, but these variants also are stored and indexed at stage 108 with consideration of their aggregated estimates. That is, index 109 contains not only highly probable options from parsing sentences, but also the improbable options that are weighted correspondingly if this parsing is successful. The weight of the version from the parsing is then used in the calculation assessing the relevance of the search result.

A wide range of lexical, grammatical, syntactic, pragmatic and semantic features are derived at the stage (106) of the analysis and construction of semantic structures (107). For example, the system can derive and store lexical information and information about the affiliation of lexical units of semantic classes, information on grammatical forms and linear order, about syntactic relations and surface positions, the use of certain forms, of aspects, of tonalities such as positive and negative tonality, deep positions, non-tree links, semantics, etc.

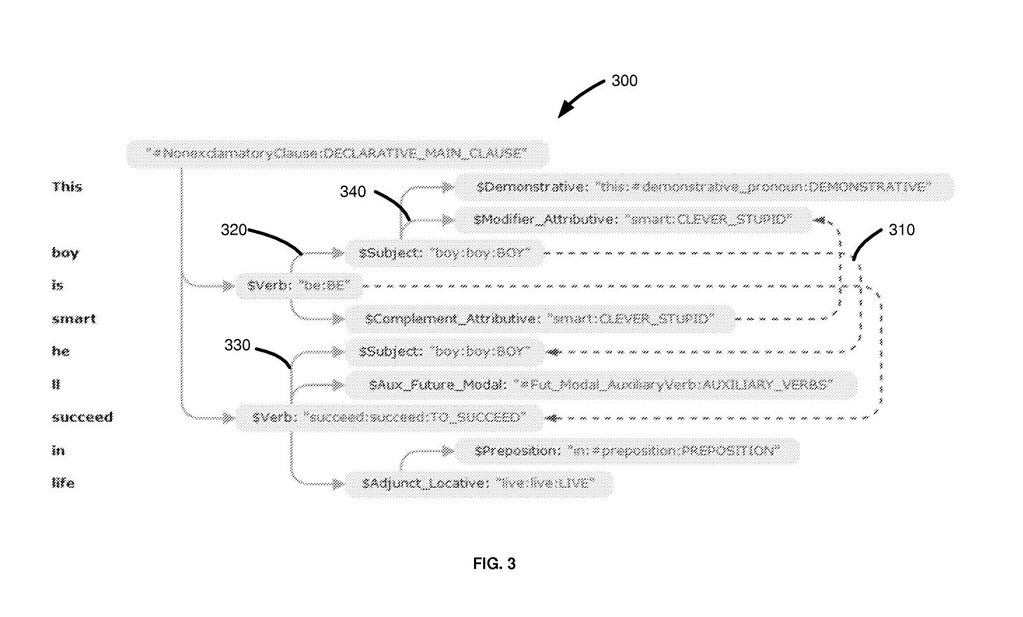

FIG. 3 illustrates an example 300 of a syntax tree resulting from a precise syntactic analysis of the English sentence “This boy is smart, he'll succeed in life.” The tree 300 is sufficiently complete in terms of syntactic information such as lexical meanings, parts of speech, syntactic roles, grammatical meanings, syntactic relationships (positions), syntactic models, types of non-tree links and so forth. For example, the pronoun “he” is 45efined in relationship to the noun “boy” as the subject of an anaphoric link (310). “Boy” is defined as the subject (320) of the verb “be.” “He” is defined as the subject (330) of the verb “succeed.” The adjective “smart” turns out to be related to the noun “boy” with the “control—complement” (340) relationship.

Referring to FIG. 2, this approach of two-stage syntactic analysis provides the construction of the best syntactic structure (246) for the given sentence, selected from one or several syntactic structures. FIG. 3 depicts a schematic of the best syntactic structure resulting from a syntactic analysis of the English sentence “This boy is smart, he'll succeed in life.” The two-stage analysis approach follows the principle of cohesive goal-driven recognition, i.e., hypotheses about the structure of a part of the sentence are checked using the existing linguistic models within the framework of the entire sentence. As a result of this approach, there is no need to analyze a number of dead-end versions of a parsing. This approach may allow a substantial reduction of the computer resources required to analyze a sentence.

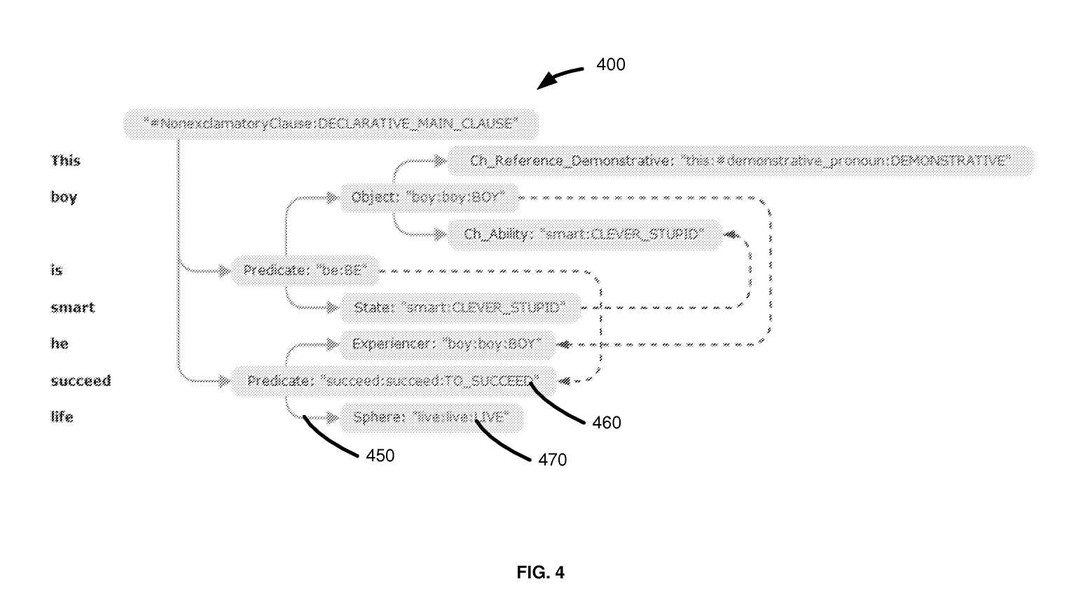

The proposed method of analysis supports the attainment of maximum precision in determining the meaning of the sentence. FIG. 4 illustrates an example 400 of a semantic structure resulting from an analysis of the English sentence “This boy is smart, he'll succeed in life.” This structure contains all the syntactic and semantic information such as semantic classes, semantemes (not shown in the drawing), semantic relations (deep positions), non-tree links, etc.

The language-independent semantic structure of the sentence is represented as an acyclic graph (trees, supplemented by non-tree links) where each word of a specific language is replaced with universal (language-independent) semantic entities called semantic classes. A semantic class is a semantic characteristic that may be derived and used for completing tasks in the semantic search, classification, clustering and filtering of documents written in one or more languages. Moreover, semantemes can be used as information in the language-independent structures, reflecting not only semantic, but also syntactic, grammatical, and other language-dependent information.

Semantic classes can be arranged in a semantic hierarchy where a “daughter” semantic class and its “descendants” inherit much of the properties of the ‘parent’ and all previous semantic classes (“ancestors”). For example the semantic class SUBSTANCE is a daughter class of the rather broad class ENTITY and at the same time is a “parent” for semantic classes GAS, LIQUID, METAL, WOOD_MATERIAL, etc. Each semantic class in a semantic hierarchy is covered by a deep (semantic) model. The deep model is a set of deep slots (types of semantic relationships in sentences). Deep slots reflect the semantic roles of daughter constituents (i.e., structural units of a sentence) in various sentences with items from this semantic class as the core of a parent constituent and possible semantic classes as items filling the slot. These deep slots reflect the semantic relationships between constituents, such as “agent,” “addressee,” “instrument” or “quantity.” The daughter class inherits and tweaks the deep model of the parent class.

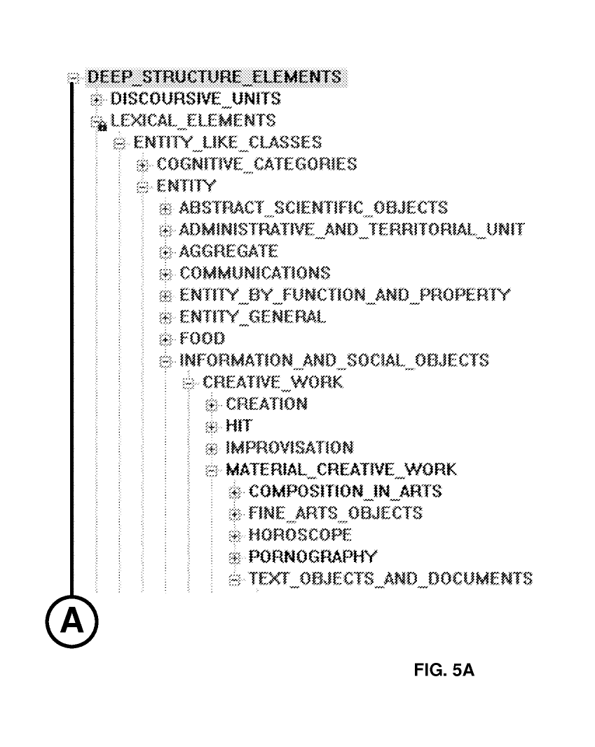

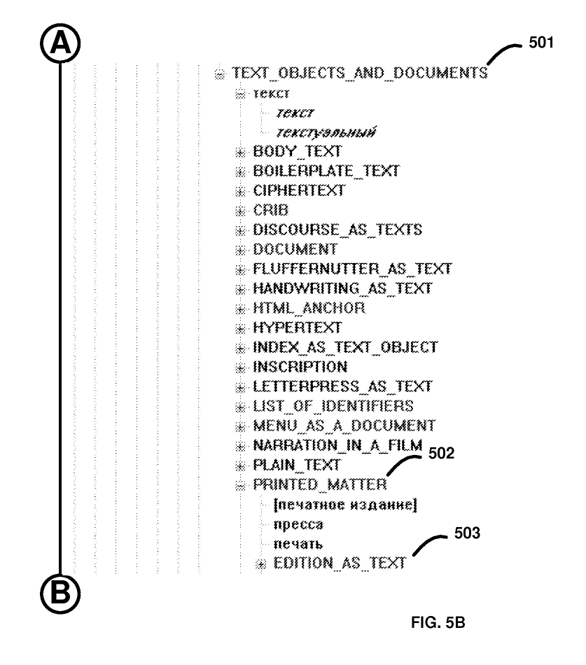

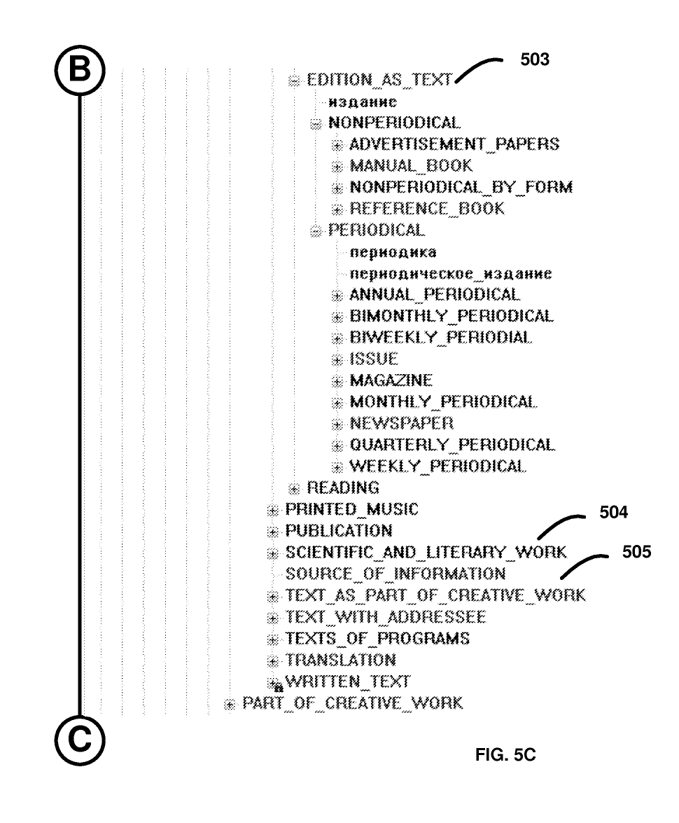

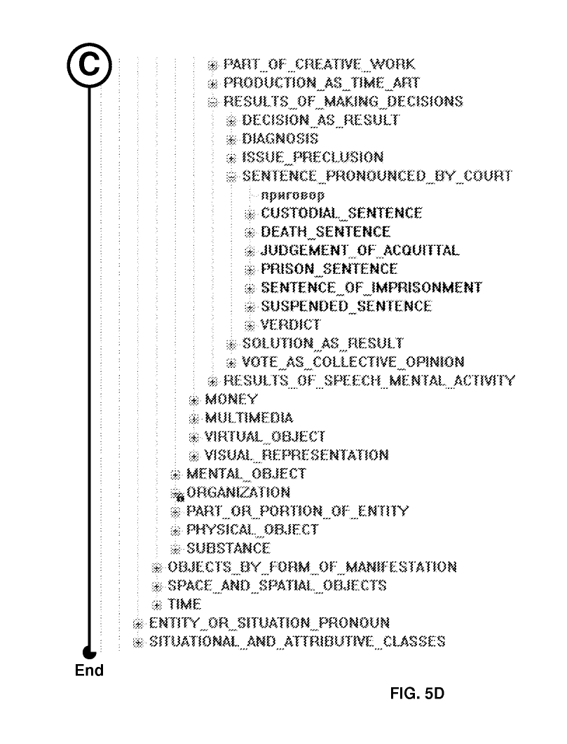

FIGS. 5A-5D each illustrate a fragment of a semantic hierarchy according to one embodiment. The semantic hierarchy is set up such that broader concepts are located at the top levels of the hierarchy. For example, in the case of documents, types of which are illustrated in FIG. 5B, and FIG. 5C, the semantic classes—PRINTED_MATTER (502), SCIENTIFIC_AND_LITERARY_WORK (504), TEXT_AS_PART_OF_CREATIVE_WORK (505) and others—are descendants of the class TEXT_OBJECTS_AND_DOCUMENTS (501) while the class PRINTED_MATTER (502), is in turn a parent for the semantic class EDITION_AS_TEXT (503), which contains the classes PERIODICAL (periodicals) and NONPERIODICAL, where PERIODICAL is the parent class for the classes ISSUE, MAGAZINE, NEWSPAPER, etc. Thus, the lexical meanings that are close in meaning, as a rule, are concentrated in the same branch of a semantic hierarchy in one semantic class, or in “related” i.e. closely located, semantic classes.

As another example, in a semantic hierarchy synonymous lexical meanings (synonyms), such as “food,” “meal,” and “alimentary,” are usually located in the same semantic class and have the same or close semantic characteristics (semantemes). If a user turns on the “Search synonyms” option during the search and wishes to find texts related to word “food,” then, at first, this word's lexical meaning and semantic class are defined and other words from the same semantic class are used in the search. As a result, the documents containing “meal” or “alimentary” and possibly other most representative members of the FOOD semantic class are found. In such cases, expanded search results may be more or less relevant, more or less close to the required result. A measure of relevance can be introduced, for example, based on assessment of “closeness” between the lexical meaning of the query and the synonym found. The measure of relevance can also take into account context, word order and other factors. The measure of relevance can also be calculated for a sentence, a text fragment, etc.

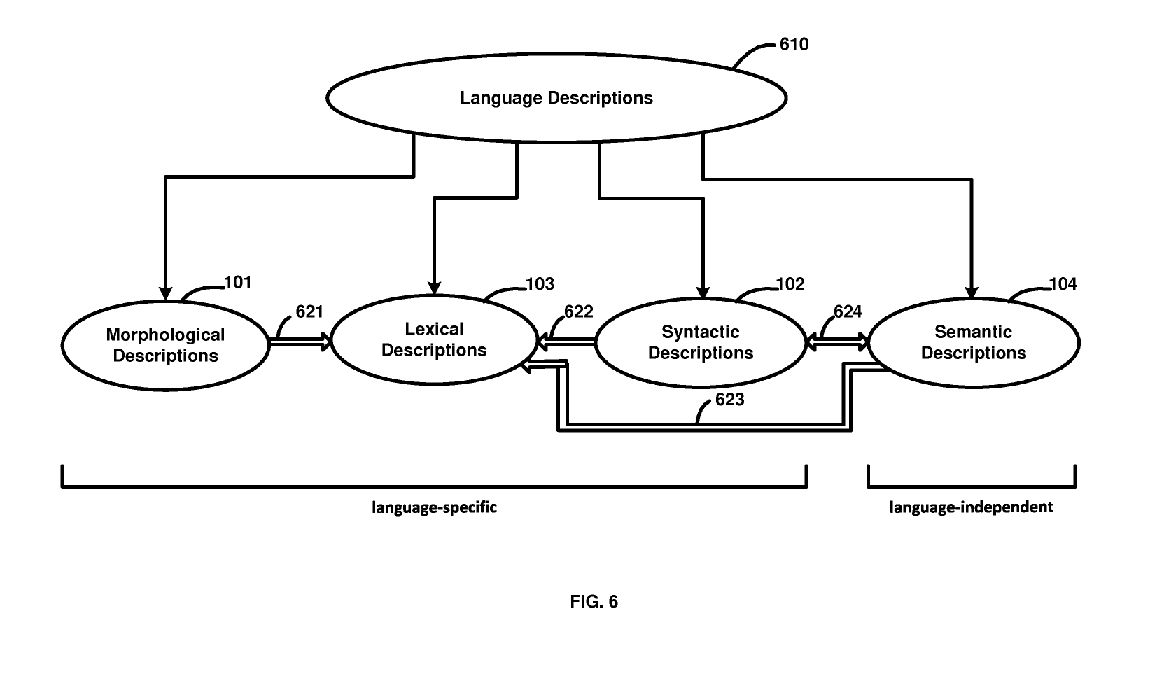

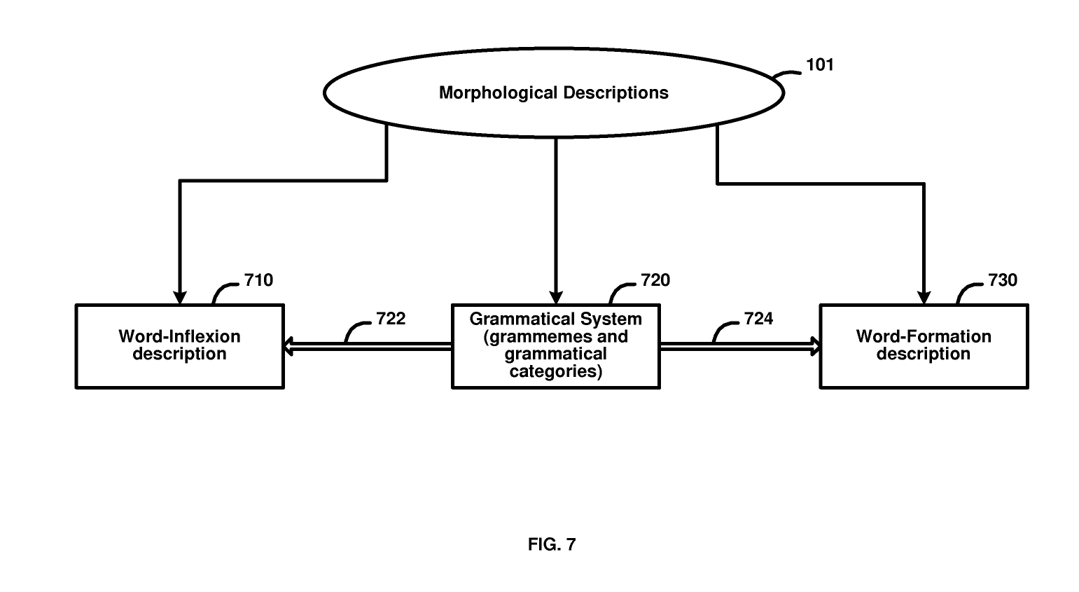

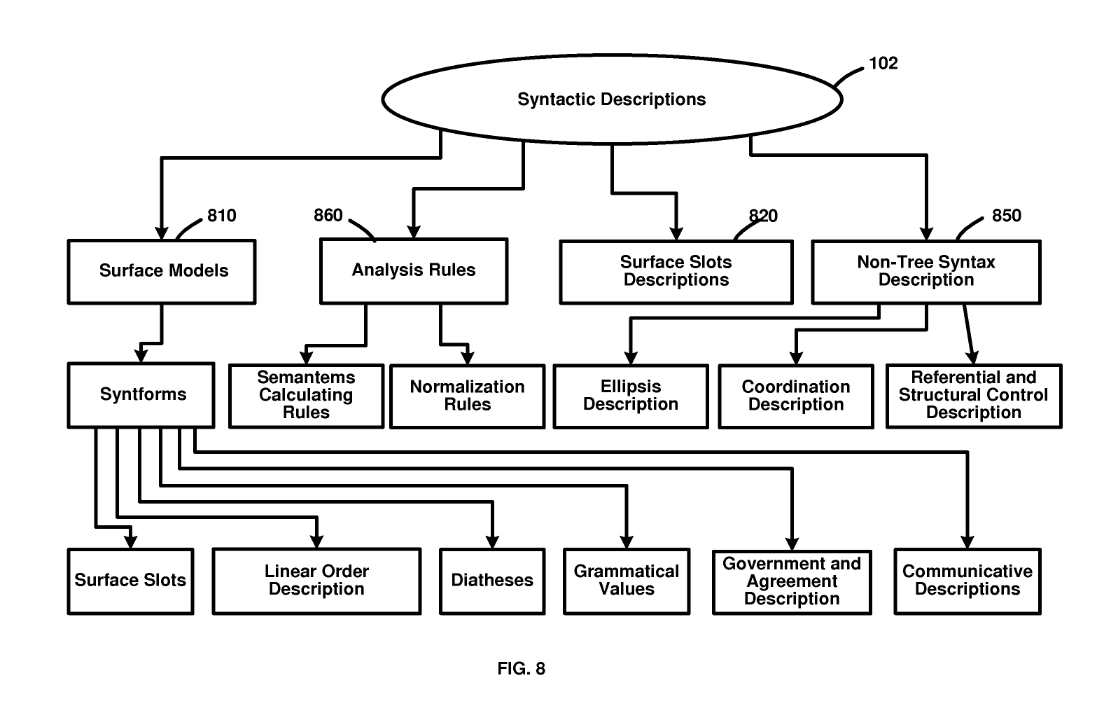

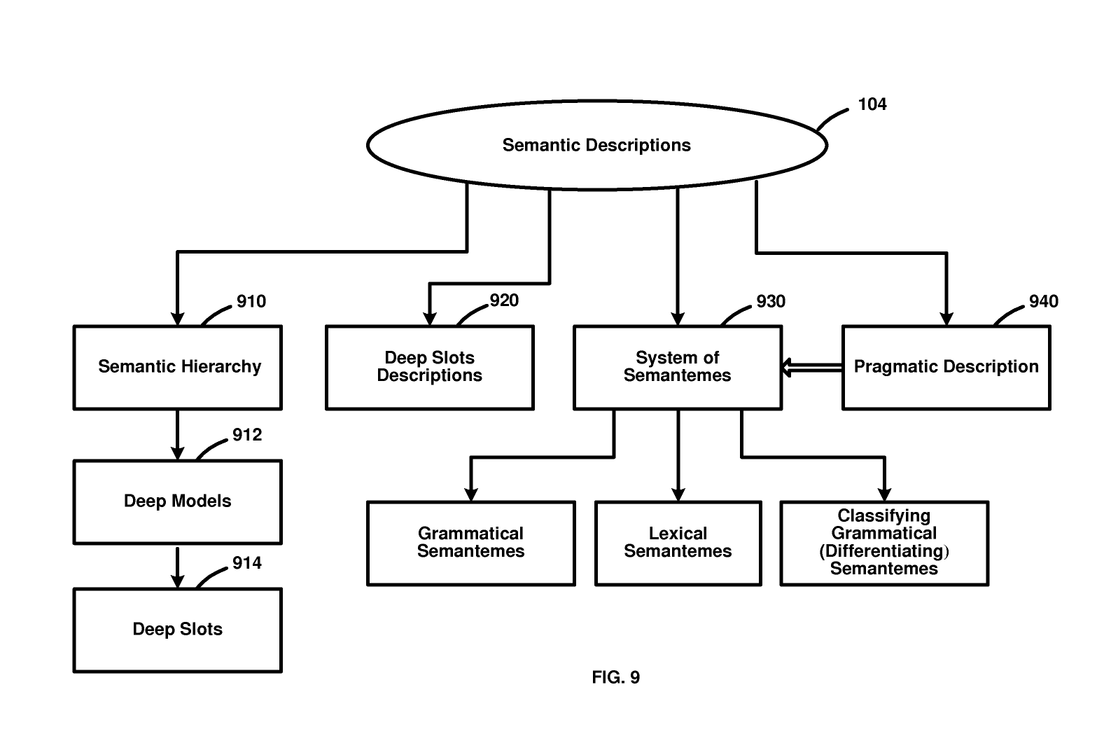

FIG. 6 is a diagram illustrating language descriptions (610) according to one embodiment. Language descriptions (610) include morphological descriptions (101), syntactic descriptions (102), lexical descriptions (103) and semantic descriptions (104). Language descriptions (610) are combined into a general concept. FIG. 7 is a diagram illustrating morphological descriptions according to one embodiment. FIG. 8 shows syntactic descriptions according to one embodiment. FIG. 9 shows semantic descriptions according to one embodiment.

Referring to FIG. 6 and FIG. 9, as part of the semantic description (104), the semantic hierarchy (910) is a characteristic of linguistic descriptions (610) that integrates language-independent semantic descriptions (104) and language-dependent lexical descriptions (103). A semantic hierarchy may be created at the same time and may later be filled in for each specific language. The semantic class in a specific language includes lexical meanings with the corresponding models. Semantic descriptions (104) are language-independent. Semantic descriptions (104) may contain a description of deep constituents and may contain a semantic hierarchy, descriptions of deep slots, and a system of semantemes and pragmatic descriptions.

Referring to FIG. 6, the morphological descriptions (101), lexical descriptions (103), syntactic descriptions (102) and semantic descriptions (104) are linked as indicated by a double arrows 621, 622, 623, and 624. Lexical meanings may have several surface (syntactic) models depending on the semantemes and pragmatic characteristics. The syntactic descriptions (102) and semantic descriptions (104) are also linked. For example, a diathesis of syntactic descriptions (102) may be seen as an “interface” between the language-dependent surface models and the language-independent deep models of the semantic description (104).

FIG. 7 illustrates components of morphological descriptions (101). As was previously shown, the constituents of morphological descriptions (101) include, but are not limited to, word-inflextion descriptions (710) and of the grammatical system (grammemes) (720) and word formation description (730). In one embodiment, the grammatical system (720) includes a set of grammatical categories such as “part of speech,” “case,” “gender,” “number,” “person,” “reflexive,” “tense,” “aspect,” and their significance, hereinafter called grammemes. For example, grammemes denoting parts of speech can include an adjective, noun, verb, etc.; case grammemes may include “Nominative”, “Genitive”, “Dative” etc.; gender grammemes may include “Male”, “Female”, “Neuter”, etc. Word-inflextion descriptions (710) describe how the base form of the word may vary depending on case, gender, number, tense, etc. and broadly include all possible forms of the word. Word formation (730) describes what new words can be constructed using this word. Grammemes are units of the grammatical system (720) and, as indicated in link (722) and link (724), grammemes can be used to construct word-inflextion descriptions (710) and word formation descriptions (730).

FIG. 8 illustrates components of syntactic descriptions (102). In one embodiment the components of the syntactic descriptions (102) may contain surface models (810), surface slot descriptions (820), analysis rules (860), and non-tree syntax descriptions (850), including referential and structural control descriptions, governance and agreement descriptions etc. The syntactic descriptions (102) are used to construct possible syntactic structures for the sentence in a given source language, taking into account word order, non-tree syntactic phenomena (e.g., coordination, ellipsis, etc.), referential relationships and other considerations.

FIG. 9 illustrates components of semantic descriptions (104) according to one embodiment. While the surface slots (820) reflect the syntactic relationships and the means to implement them in a specific language, deep slots (914) reflect the semantic role of daughter (dependent) constituents in deep models (912). Therefore, surface slot descriptions, and more broadly of surface models, can be specific for each language. The deep slots descriptions (920) contain grammatical and semantic limitations on items that can fill these slots. The properties and limitations for deep slots (914) and the items that fill them in deep models (912) may be very similar or identical for different languages.

The system of semantemes (930) represents a set of semantic categories. Semantemes may reflect lexical and grammatical categories and attributes as well as differential properties and stylistic, pragmatic and communication characteristics. For example, the semantic category “DegreeOfComparison” may be used to describe degrees of comparison expressed in different forms of adjectives, such as “easy,” “easier” and “easiest.” Likewise, the semantic category “DegreeOfComparison” may include semantemes, such as “Positive,” “ComparativeHigherDegree,” and “SuperlativeHighestDegree.” As another example, the semantic category “RelationToReferencePoint” can be used to describe the linear order—before or after the object or event is located in the sentence and the link to it, with the semantemes being “Previous”, “Subsequent”. In another example, the semantic category “EvaluationObjective” can fix the presence of an objective assessment, such as “Bad”, “Good”, etc. Lexical semantemes can describe the specific properties of objects, such as “being flat” or “being liquid” and are used in limiting the placeholders of the deep slots. Classifications of differential semantemes are used to express differential properties within a single semantic class. For example, in English, “hairdresser” for men is translated as “barber”, and in the semantic class “HAIRDRESSER” it will be assigned the semanteme “RelatedToMen”, while in the same semantic class we find “hairdresser” and “hairstylist” and so on.

Pragmatic descriptions (940) are used to assign a corresponding theme, style or genre to text during the parsing process, and it is also possible to ascribe the corresponding characteristics to objects in the semantic hierarchy. For example, “Economic Policy”, “Foreign Policy”, “Justice”, “Legislation”, “Trade”, “Finance”, etc.

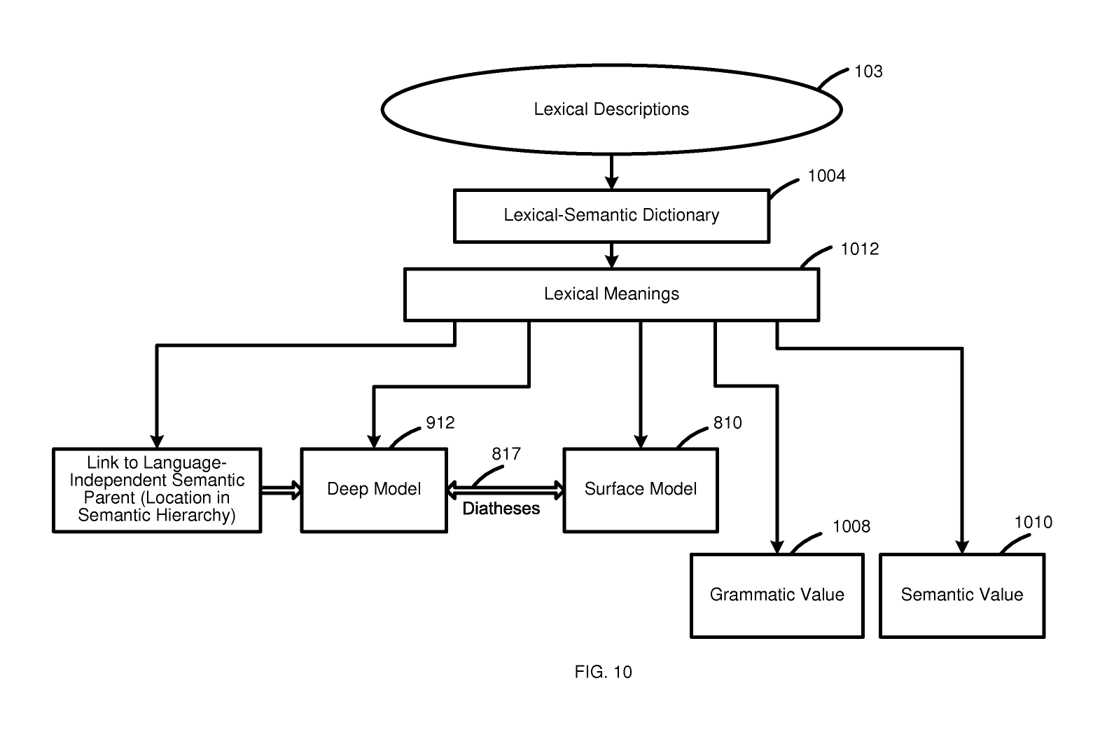

FIG. 10 is a diagram illustrating components of lexical descriptions (103) according to one embodiment. Lexical descriptions (103) include a lexical-semantic dictionary (1004), which includes a set of lexical meanings (1012) that, along with their semantic classes, form a semantic hierarchy where every lexical meaning may include, but not be restricted by, its deep model (912), its surface model (810), its grammatical value (1008) and its semantic value (1010). The lexical meaning is a realization in a specific language some semantic meaning and may link together various derivatives (such as words, expressions and phrases) that express a thought using various parts of speech, various forms of a word, words with the same root and other things. In turn, a semantic class joins the lexical meanings of words and expressions that are close in meaning in different languages.

Any parameter of linguistic description (610)—lexical meanings, semantic classes, grammemes, semantemes and more—are removed during an exhaustive analysis of the text, and any parameter can be indexed (an index specification is created). Indexing semantic classes is required in many tasks related to the analysis of natural language texts, such as semantic search, classification, clustering, filtering of texts, and much more. Indexing lexical meanings (as opposed to simply indexing the word alone) enables searches of not just words or word forms, but of the lexical meaning, that is, words in a particular semantic meaning Syntactic structure and semantic structure can also be indexed and stored for use in semantic search, classification, clustering, and document filtering.

Returning to FIG. 1, after the universal semantic structure is constructed for each sentence of each text in the corpus, syntactic and semantic structures are indexed. The lexical meanings are indexed as the result of the lexical selection at each vertex of the semantic structure, and each parameter of the morphological, syntactic, lexical and semantic descriptions can be indexed in the same way as ordinary words. The index of words in a document usually includes at least one table, where each word (lexeme or word form) encountered in the document is accompanied by a list of numbers or addresses of positions in this document. According to one embodiment, an index is built for all lexical and semantic meanings, all semantic classes, for any value of the morphological, syntactic, lexical and semantic parameters. These values are generated in a two-step process of syntactic and semantic analysis, and the resulting indices can be used to achieve higher accuracy and relevance in semantic searches in natural language text corpora. For example, the user can formulate a query with the option of searching sentences with nouns that have the property “being flat” or “being liquid”, or sentences containing words (nouns and/or verbs), denoting a process such as production, destruction, displacement, etc.

In one embodiment, a combination of two, three or, generally speaking, N numbers can be used for indexing different syntactic, semantic, or other parameters. For example, combinations of two numbers—indexes of words that in the text are linked by a relationship corresponding to the given slot—can be used to index the surface or deep slots. For example, for the semantic structure of the sentence “This boy is smart, he'll succeed in life”, depicted in FIG. 4, the deep slot ‘Sphere’ (450) relates to the lexical meaning “succeed:TO_SUCCEED” (460) with the lexical meaning “life:LIVE (470)”. More specifically, the lexical meaning “life:LIVE” fills the deep ‘Sphere’ of the verb “succeed:TO_SUCCEED”. When building an index of lexical meanings, the occurrences of these lexical meanings are assigned numbers according to their position in the text, for example, N1 and N2. When building the index of deep slots, each deep slot is assigned according to lists of its occurrence in the document. For example, the index of the deep slot ‘Sphere’ will include, among others, the pair (N1, N2).

Since not only words are indexed, but also their lexical meanings, semantic classes, syntactic and semantic relations, and any other elements of syntactic and semantic structures, it becomes possible to search the context using not only key words, but also using the context containing lexical or semantic meanings, meanings belonging to specific semantic classes, context including elements with specific syntactic and/or semantic features and/or morphological features or sets (combinations) of such features. Additionally, sentences may be found with non-tree syntactic phenomena, such as ellipses, parataxis, etc. Because semantic classes may be searched, it becomes possible to search semantically linked words and concepts.

Returning to the method of invention presented in FIG. 1, user's query 110 generally is a group of words, including a sentence, a phrase, etc., In other words a query is a set of keywords that we are looking for in searched fragment. The query is processed by semantic-syntactic analysis as shown in FIG. 2, resulting in a semantic structure and disambiguation 120 of the key words. This means that in the best case scenario, for each key word we find a specific lexical meaning, which will be used when searching text corpora. Finding a specific lexical meaning is possible when all other parsing options (other lexical variations) have assessment scores significantly lower than the first lexical meaning (below a certain threshold value). In the worst case scenario, when assessments scores of more than one lexical variation are close in value, a set of lexical variations (lexical meanings) is defined with relevant weights for the key word. In other words, a ranked list of lexical meanings is formed for the key word.

Weight (rating) of each lexical variation in the resulting semantic structure is calculated. This weight may depend on a variety of factors: coherence (compatibility of words) of the initial query, aggregated assessment obtained based on parsing of the resulting semantic structure, on a predetermined rating of the lexical meaning, or on an independent statistical compatibility scores of the words in the initial query, etc.

Further, at stage 130, for one or more elements (words) of the query, one or more synonyms can be found. In one embodiment, existing lists of synonyms can be used (e.g., WordNet synsets). In some embodiments, synonym lists are generated at least in part based on relative locations of these lexical meanings in the semantic hierarchy and on availability of certain distinguishing and classifying semantemes of lexical meaning For example, FIG. 5B illustrating a fragment of a semantic hierarchy shows semantic class PRINTED_MATTER (502), which incorporates semantic classes “printed media” and “press.” It can be considered that these lexical classes are “substantially close” to each other and, therefore, may be substituted for one another with rating 1 or, for example, 0.9 depending on the level of similarity/dissimilarity of other semantic features (e.g., presence/absence of some distinguishing semantemes). Thus, for example, if the query includes a sentence “Messages appeared in press about a comet approaching the Earth” is being analyzed, the expanded search query may also include a sentence “Messages appeared in printed media about a comet approaching the Earth.”

Semantic class PRINTED_MATTER (502), however, also includes other semantic classes such as EDITION_AS_TEXT (503), PERIODICAL, NEWSPAPER, etc. They also contain lexical classes such as PERIODICAL, NEWSPAPER, etc. When referenced to the source lexical meaning “press,” a weight (rating) of synonym “newspaper” may be calculated relative to the semantic class “press”. Roughly, this weight depends on a “distance” between these two semantic classes in semantic hierarchy and on availability/absence of any distinguishing semantemes. “Distance” may be calculated using a metric.

Depending on accuracy requirements and/or complexity of computations, metrics may also address various factors, such as availability of parent/heir relations between the two semantic classes in the semantic hierarchy, with parent and heir separated by not more than a certain number of semantic hierarchy levels; availability of common ancestor for certain semantic classes and distances between nodes representing these classes. If it is found that lexical classes (meanings) are “close,” metrics may address availability or absence of certain distinguishing semantemes and (or) other factors (e.g., similarity/difference of surface models, including availability of identical surface slots and their possible placeholders).

Thus, one or more synonyms may be selected at stage 130 for one or more query elements (words), each having its own factor (weight, rating) relative to the word originally present in the query. For example, the weight may have values between 0 and 1, where the highest weight (1) belongs to the original word present in the query.

At stage 140, synonyms are ranked in descending order based on their ratings. Additional queries are formulated based on these synonyms. These additional queries include all possible combinations (Cartesian behavior) of the synonyms with preservation of their ranking order based on the weight of each synonym included in the query. The highest weight (1) will belong to the original query.

At stage 150, actual search is performed. More specifically, more than one additional search may be used for expanded search. A few queries can be performed simultaneously or in series. A computer system having more than one processor can be used. The expanded search query includes additional lexical meanings that have been identified. Each additional query of the expanded search query has its own weight calculated at stage 140.

A full text search or a semantic search can be performed at stage 150. For the full text search, each query is transformed into individual words, and the search is performed based on these words using an index, usually a word index. An N-gram index can also be used for the full text search. In case of the full text search, an additional results filtration can be performed. The filtration includes a semantical-syntactic breakdown of found fragment to ensure that the words in the found fragments are used in the same lexical meaning as in the query.

In case of a semantic search, at stage 150 the semantic search is performed using a semantic index (i.e., a search is performed for specific lexical meanings). In some embodiments the semantic search includes a search through semantic classes with further clarification based on lexical meanings In yet another embodiment, the semantic search includes searching a semantic structure corresponding to the query and subsequent computation of quality ratings for the found matches. Semantic structure index included in the semantic index can be built in advance.

In both cases, each of the found results (fragments) receives its weight depending on the weight of a corresponding search line being used for locating this fragment. Additional penalties reducing the weight of the result may be applied, for example, in case of a non-zero distance between the query words in the found fragment or in case of a change of linear order of the words.

Stage 160 includes overall ranking of the found results. Ranking may be performed based on the received weights. A conversion function may also be used. The results having weight lower than some threshold value may be discarded. Additionally, search results may be displayed 170 by the computer system in a user interface in accordance with requirements of a search engine.

Similarly to the way additional query lines are built using synonyms, paraphrases may be used to generate alternative query lines expressing the same meaning Paraphrases are sets of word groups where each word group may contain one or more words. Each word group in the set has the same meaning as the other word groups from the set. Such paraphrases may be obtained, for example, as a result of statistics gathering during processing of a plurality of texts. Such paraphrases, for example, may include word groups “during problem resolution” and “during search for problem solution.” In case of a full text search, the paraphrases may be used similarly to synonyms. Word groups in paraphrases may also have predetermined weights assigned to them based on the extent of the match between them. For example, the weight of a paraphrase may be calculated depending on an occurrence rate in similar or identical contexts.

Paraphrases may also be used during a semantic search. In one embodiment, paraphrase may replace a fragment of a query before the syntactic analysis if this is feasible, for example, because another equivalent phrase has a higher occurrence rate. Paraphrases may also be generated dynamically as follows. At stage 120 the query was subjected to the semantic-syntactic analysis for disambiguation and a semantic structure was built for the original query. The semantic-syntactic analysis technology is an integral part of machine translation technology and has been described in a number of patents, such as U.S. Pat. No. 8,195,447, U.S. Pat. No. 8,214,199, etc. The resulting semantic structure may be used for the synthesis of an equivalent sentence in any language, including the source language of the query. The technology allows us to generate a plurality of versions of the sentence rather than a single surface syntactic structure. The technology further includes assessment of each version of the sentence and selection of the versions with highest rating. The surface syntactic structures may also include different lexical variations. After the search for paraphrases is completed, the best results are selected based on the surface structures with rating exceeding some threshold value.

Certain rules may apply to the assessment of the versions of the surface structures. For example, various surface structures of paraphrases may be used for a source sentence “John bought a house by a river”—“A house by a river was bought by John” and even “A house by a river was sold to John.” These versions have computable ratings that depend on a number of factors, including the degree of similarity of synthesized structure in relation to the structure of the source sentence, availability of corresponding semantic classes, deep and surface slots and semantemes, “degree of closeness” of lexical classes, selected grammatical forms, etc. A certain threshold of acceptable “deviation” from the source sentence is established, and the versions with the rating exceeding this threshold may be selected as paraphrases to be used in the query.

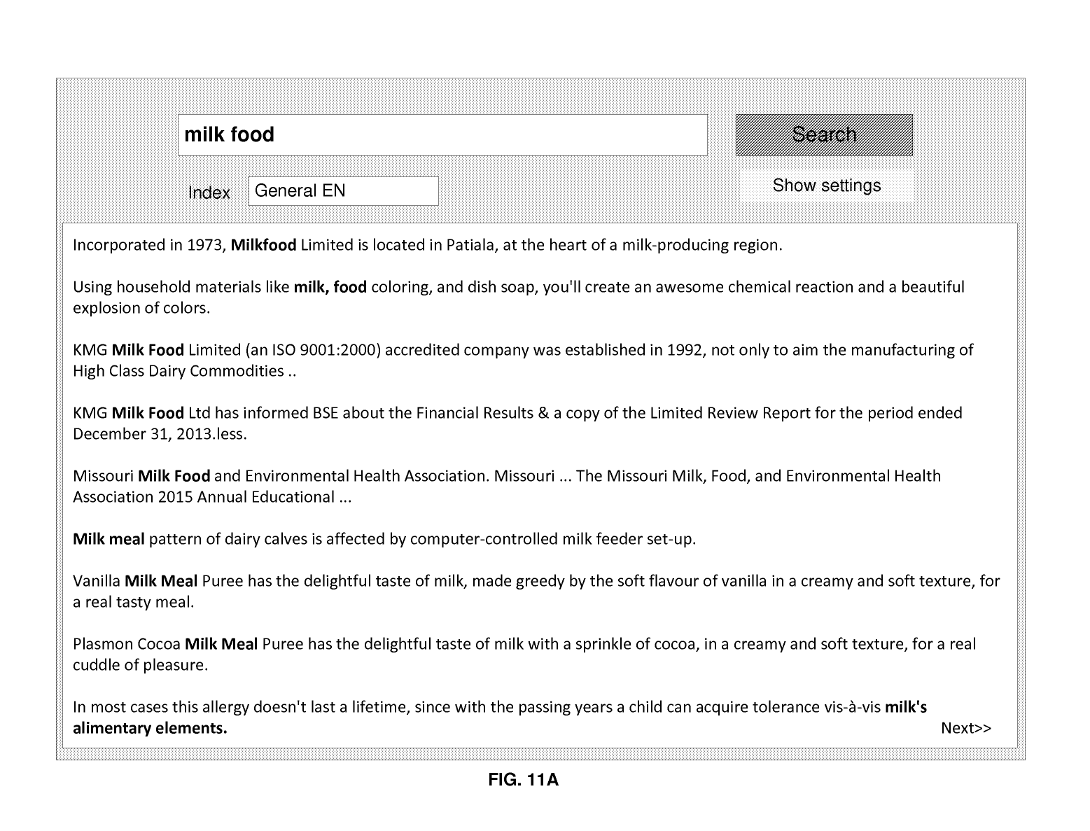

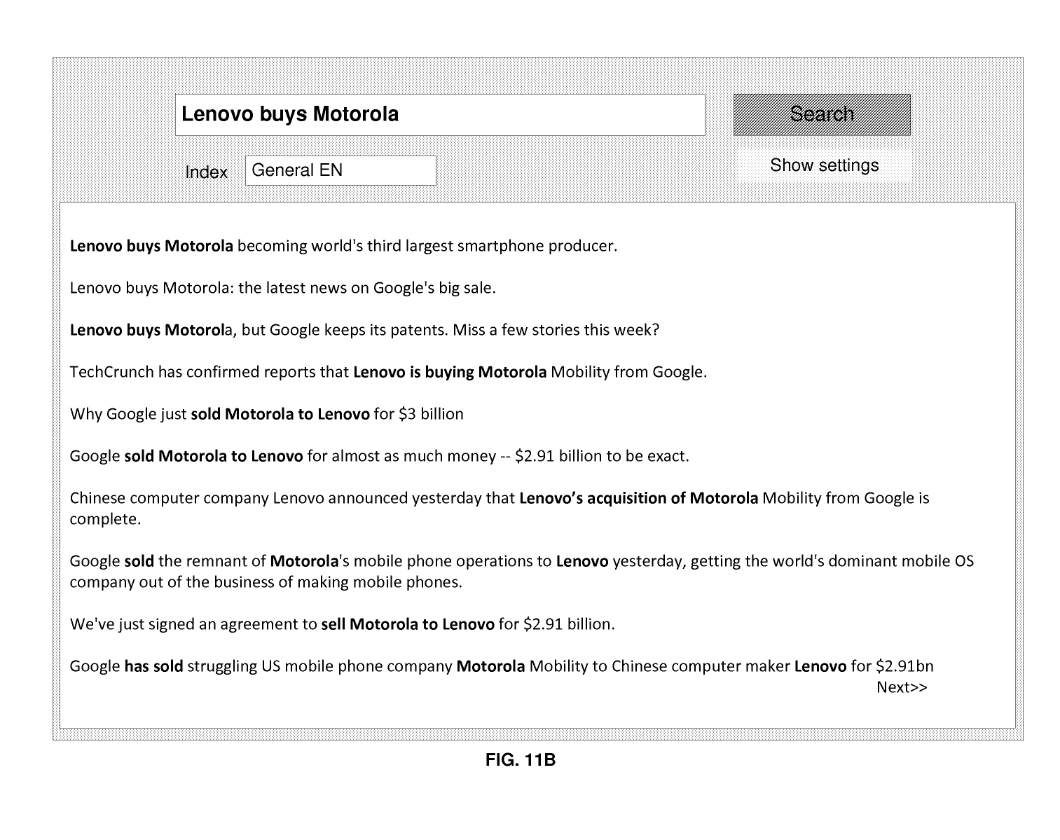

FIGS. 11A illustrate an example of graphical user interface displaying search results of a query using synonyms. FIGS. 11B illustrate another example of graphical user interface displaying search results of query using paraphrases.

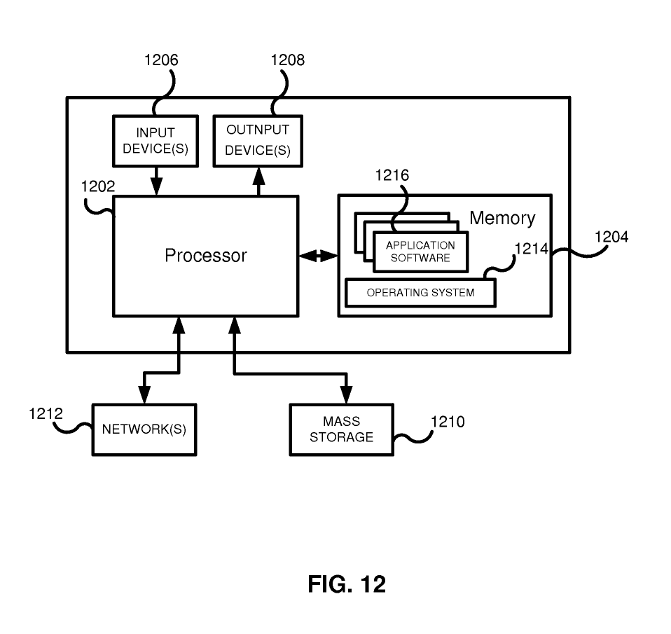

FIG. 12 shows an examplary computer platform (1200) for implementing the techniques and systems described herein. The computer platform (1200) includes at least one processor (1202) connected to a memory (1204). The processor (1202) may be one or more processors and may contain one, two, or more computer cores. The memory (1204) may be random access memory RAM and may also contain any other types or kinds of memory, particularly non-volatile memory devices (such as flash drives) or read-only memory devices such as hard drives, etc. In addition, an arrangement can be considered in which the memory (1204) includes storage media built into the equipment for information physically located somewhere else, as well on the computer platform (1200) such as a cache in the processor (1202), and memory used as a virtual device and stored on external or internal ROM (1210).

The computer platform (1200) may also include a number of input and output ports to transfer information out and to receive information. For interaction with a user, the computer platform (1200) may contain one or more input devices (such as a keyboard, a mouse, a scanner, and so forth) and a display device (1208) (such as a liquid crystal display). The computer platform (1200) may also have one or more read-only memory devices (1210) such as an optical disk drive (CD, DVD or other), a hard disk, or a tape drive. In addition, the computer platform (1200) may have an interface with one or more networks (1212) that provide connections with other networks and computer equipment. In particular, this may be a local area network (LAN), a wireless Wi-Fi network and may or may not be connected to the World Wide Web (Internet). It is understood that the computer facilities (1200) include appropriate analog and/or digital interfaces between the processor (1202) and each of the components (1204, 1206, 1208, 1210 and 1212).

The computer facilities (1200) are managed by the operating system (1214) and include various applications, components, programs, objects, modules and other, designated by the consolidated number 1216.

The programs used to implement the disclosed methods may be a part of an operating system or may be a specialized application, component, program, dynamic library, module, script, or a combination thereof. The disclosed methods and systems cannot be limited by the hardware mentioned earlier.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be changed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed:

1. A method of organizing a search in electronic text corpora for computer system, with the following actions carried out at least once:
performing a semantic-syntactic analysis of a search query, comprising building a ranked list of possible lexical meanings for at least one word of the search query;
compiling a list of synonyms for at least one lexical meaning from the ranked list of possible lexical meanings of the at least one word of the search query;
ranking synonyms from the list of synonyms for the at least one lexical meaning;
generating query versions based on the ranked synonyms;
calculating a rating of correspondence of the query versions to the search query;
searching for text fragments in the electronic text corpora satisfying the query based on at least one of the query versions;
ranking the found text fragments based on the ratings of correspondence of the query versions to the search query.

2. The method of claim 1, further comprising
preliminary generating at least one index of words from the text corpora; and
saving the index of words in a memory.

3. The method of claim 1, further comprising:
conducting preliminary semantic and syntactic analysis of the text corpora comprising determining lexical meanings of words in sentences from the text corpora;
constructing a semantic structures of the sentences from the textcorpora;
storing in memory results of the semantic and syntactic analysis; and
indexing the text corpora based on the semantic structures and storing the indexes.

4. The method of claim 2, further comprising
performing a semantic-syntactic analysis of the text fragments to determine most probable lexical meanings of the words in the sentences; and
assessment of correspondence of lexical meanings of words in found fragments to lexical meanings of words in the variation of source query.

5. The method of claim 3, further comprising:
computing aggregated assessment of correspondence of the found fragment to the query version; and
ranking the fragments in accordance with the rating of their corresponding query version of the search query and the value of aggregated assessment of correspondence of the found fragment to the query version.

6. The method of claim 4, further comprising:
computing aggregated assessment of correspondence of the found fragment to the query version; and
ranking the fragments in accordance with the rating of their corresponding query version of the search query and the value of aggregated assessment of correspondence of the found fragment to the query version.

7. The method of claim 1, wherein the semantic and syntactic analysis of the search query comprises building a semantic structure of the search query.

8. The method of claim 7, further comprising building search query versions based on paraphrases of at least a part of the search query.

9. The method of claim 8, wherein the paraphrases of at least the part of the search query are obtained as a synthesis of at least one fragment in natural language based on at least one fragment of the semantic structure obtained based on the semantic-syntactic analysis of the search query.

10. The method of claim 9, wherein the obtained paraphrases are ranked based on degree of semantic proximity to the search query.

11. A system for organizing a search in electronic text corpora of natural language texts, the system comprising:
one or more data processors; and
one or more storage devices storing instructions that, when executed by the one or more data processors, cause the one or more data processors to perform operations comprising:
performing a semantic-syntactic analysis of a search query, comprising building a ranked list of possible lexical meanings for at least one word of the search query;
compiling a list of synonyms for at least one lexical meaning from the ranked list of possible lexical meanings of the at least one word of the search query;
ranking synonyms from the list of synonyms for the at least one lexical meaning;
generating query versions based on the ranked synonyms;
calculating a rating of correspondence of the query versions to the search query;
searching for text fragments in the electronic text corpora satisfying the query based on at least one of the query versions;
ranking the found text fragments based on the ratings of correspondence of the query versions to the search query.

12. The system of claim 11, further comprising preliminary generating at least one index of words from the text corpora; and saving the index of words in a memory.

13. The system of claim 11, further comprising:
conducting preliminary semantic and syntactic analysis of the text corpora comprising determining lexical meanings of words in sentences from the text corpora;
constructing a semantic structures of the sentences from the text corpora;
storing in memory results of the semantic and syntactic analysis; and
indexing the text corpora based on the semantic structures and storing the indexes.

14. The system of claim 12, further comprising:
performing a semantic-syntactic analysis of the text fragments to determine most probable lexical meanings of the words in the sentences; and
assessment of correspondence of lexical meanings of words in found fragments to lexical meanings of words in the variation of source query.

15. The system of claim 13, further comprising:
computing aggregated assessment of correspondence of the found fragment to the query version; and
ranking the fragments in accordance with the rating of their corresponding query version of the search query and the value of aggregated assessment of correspondence of the found fragment to the query version.

16. The system of claim 14, further comprising:
computing aggregated assessment of correspondence of the found fragment to the query version; and
ranking the fragments in accordance with the rating of their corresponding query version of the search query and the value of aggregated assessment of correspondence of the found fragment to the query version.

17. The system of claim 11, wherein the semantic and syntactic analysis of the search query comprises building a semantic structure of the search query.

18. The system of claim 17, further comprising building search query versions based on paraphrases of at least a part of the search query.

19. The system of claim 18, wherein the paraphrases of at least the part of the search query are obtained as a synthesis of at least one fragment in natural language based on at least one fragment of the semantic structure obtained based on the semantic-syntactic analysis of the search query.

20. The system of claim 19, wherein the obtained paraphrases are ranked based on degree of semantic proximity to the search query.
